(19) United States
(12) Patent Application Publication
(10) Pub. No.: US 2022/0138635 A1
(43) Pub. Date: May 5, 2022

(54) INFORMATION PROCESSING DEVICE, INFORMATION PROCESSING SYSTEM, INFORMATION PROCESSING METHOD, AND TERMINAL DEVICE

(71) Applicant: TOYOTA JIDOSHA KABUSHIKI KAISHA, Aichi-ken (JP)

(72) Inventors: Takumi SHIBANO, Nagoya-shi (JP); Kazutaka KIMURA, Mishima-shi (JP)

(21) Appl. No.: 17/469,888

(22) Filed: Sep. 9, 2021

(30) Foreign Application Priority Data
Nov. 4, 2020 (JP) 2020-184674

(51) Int. Cl. G06Q 10/02

(52) U.S. Cl. CPC G06Q 10/02

(57) ABSTRACT

An information processing device includes: an interface configured to acquire information on a travel request from a user via a terminal device of the user and to acquire information on a distribution network configured to supply electric power to at least one transportation mode usable by the user; and a controlling portion configured to determine a transportation mode to be proposed to the user based on the information on the travel request from the user and the information on the distribution network and to output information on the transportation mode thus determined to the terminal device.

### CROSS-REFERENCE TO RELATED APPLICATION

This application claims priority to Japanese Patent Application No. 2020-184674 filed on Nov. 4, 2020, incorporated herein by reference in its entirety.

### BACKGROUND

### 1. Technical Field

This disclosure relates to an information processing device, an information processing system, an information processing method, and a terminal device.

### 2. Description of Related Art

In the related art, as a configuration related to charting of a battery in a vehicle, Japanese Unexamined Patent Application Publication No. 2016-134160 (JP 2016-134160 A), for example, describes such a configuration that future charging amounts of electric vehicles in a given area are predicted so as to predict power demand in the area accurately, and utilization of natural energy power generation is raised so as to contribute to improvement in the quality of a smart community.

### SUMMARY

Improvement in stability of power supply has been demanded.

An object of this disclosure accomplished in view of such circumstances is to improve stability of power supply.

An information processing device according to one embodiment of this disclosure includes an interface and a controlling portion. The interface is configured to acquire information on a travel request from a user via a terminal device of the user and to acquire information on a distribution network configured to supply electric power to at least one transportation mode usable by the user. The controlling portion is configured to determine a transportation mode to be proposed to the user based on the information on the travel request from the user and the information on the distribution network and to output information on the transportation mode thus determined to the terminal device.

An information processing system according to one embodiment of this disclosure includes the information processing device and the terminal device.

An information processing method according to one embodiment of this disclosure includes acquiring information on a travel request from a user via a terminal device of the user. The information processing method includes acquiring information on a distribution network configured to supply electric power to at least one transportation mode usable by the user. The information processing method includes determining a transportation mode to be proposed to the user based on the information on the travel request from the user and the information on the distribution network and to output information on the transportation mode thus determined to the terminal device.

A terminal device according to one embodiment of this disclosure includes a controlling portion. The controlling portion receives an input of information on a travel request from a user and outputs the information to an information processing device. The controlling portion acquires, from the information processing device, information on a transportation mode proposed based on the information on the travel request from the user and information on a distribution network configured to supply electric power to at least one transportation mode usable by the user. The controlling portion notifies the user of the information on the transportation mode.

With the information processing device, the information processing system, the information processing method, and the terminal device according to one embodiment of this disclosure, stability of power supply can be improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view illustrating an exemplary configuration of an information processing system according to one embodiment;

FIG. 2 is a block diagram illustrating an exemplary configuration of the information processing system according to one embodiment;

FIG. 3 is a view illustrating an example of a screen that proposes transportation modes to a user in a map form;

FIG. 4 is a view illustrating an example of a screen that proposes transportation modes to the user in a list form;

FIG. 5 is a flowchart illustrating an exemplary procedure of an information processing method according to one embodiment; and

FIG. 6 is a flowchart illustrating an exemplary procedure of a terminal control method according to one embodiment.

### DETAILED DESCRIPTION OF EMBODIMENTS

Exemplary Configuration of Information Processing System 1

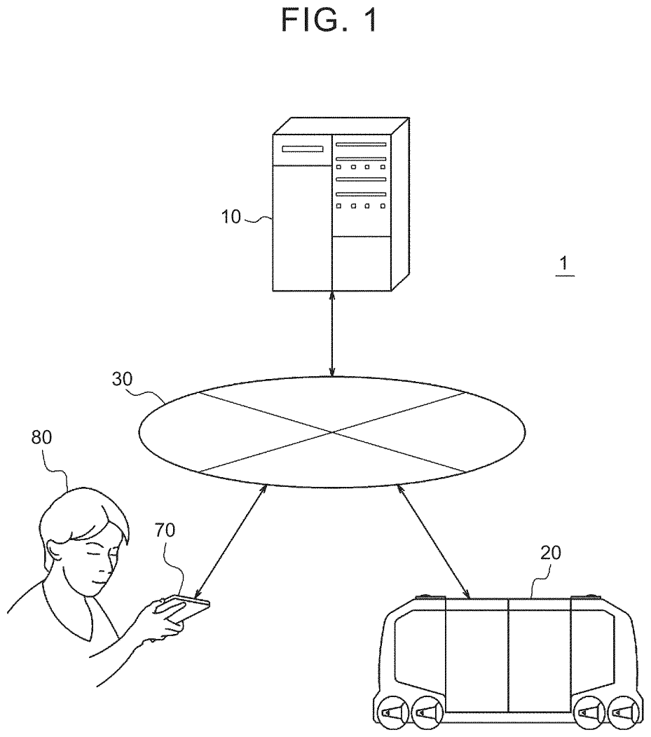

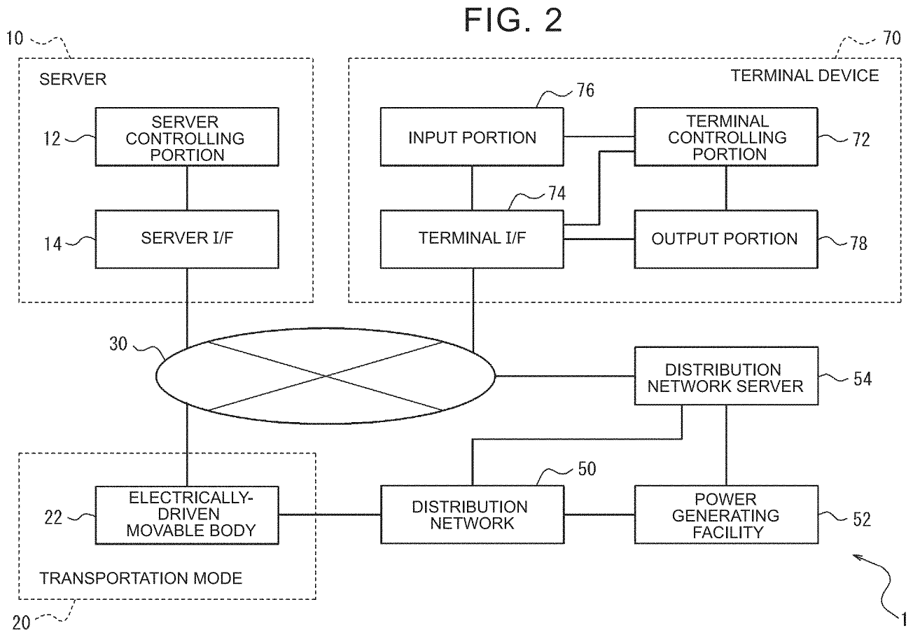

As illustrated in FIGS. 1, 2, an information processing system 1 according to one embodiment includes a server 10 and a terminal device 70 used by a user 80.

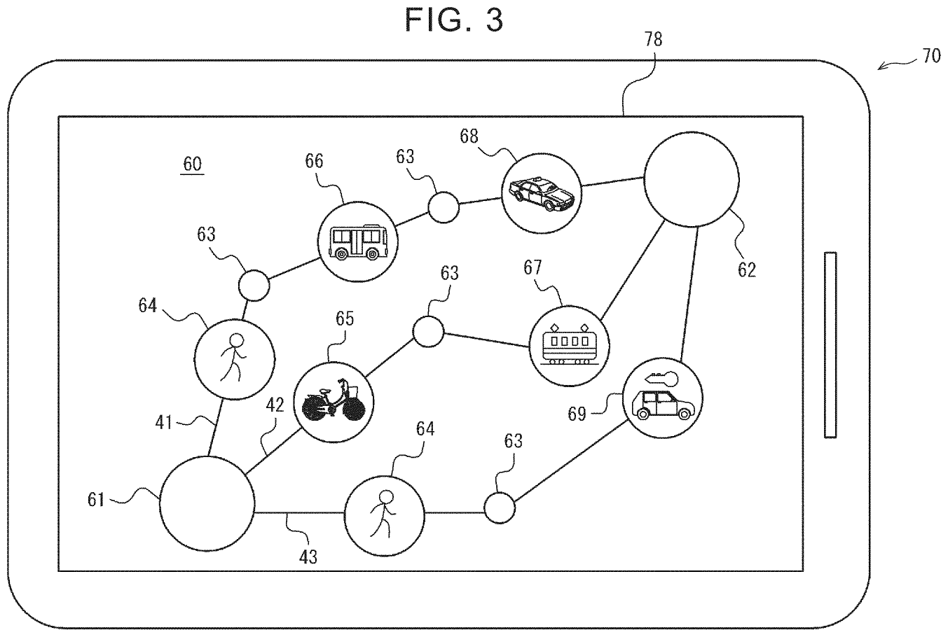

When the user 80 wants to travel, the information processing system 1 acquires information on a travel request from the user 80 and proposes the use of a transportation mode 20 to the user 80 based on the information. The information on the travel request from the user 80 is also referred to as travel information. The travel information includes information to specify a departure point 61 (see FIG. 3) and a goal point 62 (see FIG. 3) of the user 80. The travel information may include information to specify a departure time or an arrival time.

At least one transportation mode 20 is driven by consuming electric power supplied from a distribution network 50. The information processing system 1 proposes the use of a transportation mode 20 to the user 80 further based on information on the distribution network 50 configured to supply electric power to the at least one transportation mode 20. The information on the distribution network 50 is also referred to as distribution network information. The distribution network information includes information on power demand in the distribution network 50. The distribution network information may include information on maximum electric power suppliable by the distribution network 50. The distribution network information may include information on a ratio of the power demand to the suppliable maximum electric power. The ratio of the power demand to the suppliable maximum electric power is also referred to as a power usage rate. The distribution network information may include a difference between the suppliable maximum electric power and actual power demand The difference between the suppliable maximum electric power and the actual power demand is also referred to as a reserve supply capability. The distribution network information may include information on a ratio of the reserve supply capability to the suppliable maximum electric power. The ratio of the reserve supply capability to the suppliable maximum electric power is also referred to as a power reserve rate.

The information processing system 1 may determine which proposal is to be made to the user 80, a proposal to use a transportation mode 20 that consumes electric power or a proposal to use a transportation mode 20 that does not consume electric power, based on the distribution network information or the power usage rate, the power reserve rate, or the like included in the distribution network information. The information processing system 1 may determine which proposal is to be made to the user 80, a proposal to use a transportation mode 20 that consumes much electric power or a proposal to use a transportation mode 20 that does not consume much electric power, based on the distribution network information or the power usage rate, the power reserve rate, or the like included in the distribution network information.

That is, the information processing system 1 determines a transportation mode 20 the use of which is proposed to the user 80 based on the travel information and the distribution network information. The following describes an exemplary configuration of the information processing system 1.

Server 10

The server 10 includes a server controlling portion 12 and a server interface 14. The server interface 14 is also referred to as a server I/F 14.

The server controlling portion 12 controls constituent parts of the server 10. The server controlling portion 12 is also just referred to as a controlling portion. The server controlling portion 12 may include one or more processors. In the present embodiment, the “processor” indicates a general purpose processor, a dedicated processor specialized in a specific process, or the like but is not limited to them. The server controlling portion 12 may include one or more dedicated circuits. The dedicated circuits may include, for example, a field-programmable gate array (FPGA) or an application specific integrated circuit (ASIC). The server controlling portion 12 may include the dedicated circuits instead of the processors or may include the dedicated circuits as well as the processors.

The server 10 may further include a storage portion. The storage portion is a semiconductor memory, a magnetic memory, an optical memory, or the like, for example, but the storage portion is not limited to them. The storage portion may function as a main storage device, an auxiliary storage device, or a cache memory, for example. The storage portion may include an electromagnetic storage medium such as a magnetic disk. In the storage portion, given information to be used for operation of the server 10 is stored. For example, in the storage portion, a system program, an application program, and so on may be stored. The storage portion may be included in the server controlling portion 12.

Information, data, or the like is output from the server controlling portion 12 via the server I/F 14, and information, data, or the like is input into the server controlling portion 12 via the server I/F 14. The server I/F 14 is also just referred to as an interface or an I/F.

The server I/F 14 may include a communications module configured to be communicable with the transportation modes 20 via a network 30. The communications module may include a communications module corresponding to mobile communication standards such as 4th Generation (4G) and 5th Generation (5G), for example, but the communications module is not limited to them. The server I/F 14 may be configured to be communicable with the communications module.

The server 10 may include one server device or a plurality of server devices communicable with each other. The server 10 is also referred to as an information processing device.

Terminal Device 70

The terminal device 70 is configured to be usable by the user 80. The terminal device 70 may be possessed by the user 80. The terminal device 70 may include a mobile phone such as a smartphone, for example. The terminal device 70 may include a personal computer (PC) such as a laptop PC or a tablet PC. The terminal device 70 is not limited to these examples and may include various devices.

The terminal device 70 includes a terminal controlling portion 72 and a terminal interface 74. The terminal interface 74 is also referred to as a terminal I/F 74.

The terminal controlling portion 72 controls constituent parts of the terminal device 70. The terminal controlling portion 72 is also just referred to as a controlling portion. The terminal controlling portion 72 may configured identically or similarly to the server controlling portion 12 of the server 10. The terminal controlling portion 72 may include one or more processors. The terminal controlling portion 72 may include one or more dedicated circuits. The dedicated circuits may include an FPGA or an ASIC, for example. The terminal controlling portion 72 may include the dedicated circuits instead of the processors or may include the dedicated circuits as well as the processors.

The terminal device 70 may further include a storage portion. The storage portion of the terminal device 70 may configured identically or similarly to the storage portion of the server 10. The storage portion is a semiconductor memory, a magnetic memory, an optical memory, or the like, for example, but the storage portion is not limited to them. The storage portion may function as a main storage device, an auxiliary storage device, or a cache memory, for example. The storage portion may include an electromagnetic storage medium such as a magnetic disk. In the storage portion, given information to be used for operation of the terminal device 70 is stored. For example, in the storage portion, a system program, an application program, and so on may be stored. The storage portion may be included in the terminal controlling portion 72.

Information, data, or the like is output from the terminal controlling portion 72 via the terminal I/F 74, and information, data, or the like is input into the terminal controlling portion 72 via the terminal I/F 74. The terminal I/F 74 is also just referred to as an interface or an I/F.

The terminal I/F 74 may be configured identically or similarly to the server I/F 14. The terminal I/F 74 may include a communications module configured to be communicable with the transportation modes 20 via the network 30. The communications module may include a communications module corresponding to mobile communication standards such as 4G and 5G, for example, but the communications module is not limited to them. The terminal I/F 74 may be configured to be communicable with the communications module.

The terminal device 70 may further include an input portion 76. The input portion 76 includes an input device configured to receive an input of information, data, or the like from the user 80. The input device may include a touch panel, a touch sensor, or a pointing device such as a mouse, for example. The input device may include a physical key. The input device may include an audio input device such as a microphone.

The terminal device 70 may further include an output portion 78. The output portion 78 includes an output device configured to output information, data, or the like to the user 80. The output device may include a display device configured to output visual information such as images, letters, figures, or the like, for example. The display device may include, for example, a liquid crystal display (LCD), an organic electro-luminescence (EL) display, an inorganic EL display, a plasma display panel (PDP), or the like. The display device is not limited to these displays and may include any of displays of various other methods. The display device may include a light emitting device such as a light emission diode (LED) or a laser diode (LD). The display device may include various other devices. The output device may include an audio output device such as a speaker configured to output auditory information such as audio, for example. The output device is not limited to these examples and may include various other devices.

The number of the terminal devices 70 included in the information processing system 1 is not limited to one and may be two or more.

Transportation Modes 20

The information processing system 1 may determine various movable bodies configured to be usable for the user 80 to travel as transportation modes 20 the use of which is proposed to the user 80. The transportation modes 20 may include, for example, transportation using a movable body such as a train or a shuttle bus that is operated along a predetermined route. The transportation modes 20 may include, for example, transportation using a movable body such as an on-demand bus or a taxi that is operated in response to a request from the user 80. The transportation modes 20 may include transportation using a movable body that is lent to the user 80 so that the user 80 operates the movable body. The movable body in this case is, for example, a shared car, a rental car, a rental cycle, or the like. The transportation modes 20 may include transportation in which the user 80 travels by walking or the like without using any movable body.

The transportation modes 20 are classified to an electrically-driven movable body 22 driven by consuming electric power and a non-electrically-driven movable body driven without consuming electric power. The electrically-driven movable body 22 is driven by consuming electric power supplied from the distribution network 50. The electrically-driven movable body 22 may be driven by just consuming electric power supplied from the distribution network 50. The electrically-driven movable body 22 may charge its battery with electric power supplied from the distribution network 50 and may be driven by consuming electric power discharged from the battery. The non-electrically-driven movable body is driven by consuming fossil fuel such as gasoline or gas or other energy sources, for example. The non-electrically-driven movable body may be driven by the user 80.

The operations of the transportation modes 20 may be managed by the information processing system 1. The information processing system 1 may manage an operation schedule for a movable body that is operated along a predetermined route, the movable body being, for example, a shuttle bus, a train, or the like. The information processing system 1 may manage the operation of an on-demand bus or a taxi, for example, in response to a request from the user 80. The information processing system 1 may manage a rental state of a shared car, a rental car, a rental cycle, or the like, for example.

The number of types of the transportation modes 20 as management targets to be managed by the information processing system 1 is not limited to one and may be two or more. The transportation modes 20 may include a movable body configured to move by self-driving or automatic operation. In a case where the transportation mode 20 is a vehicle, the self-driving may be performed at any levels from level 1 to level 5 defined by Society of Automotive Engineers (SAE), for example. The self-driving is not limited to the definition described here and may be performed based on other definitions.

Distribution Network 50

The distribution network 50 electrically connects a power source such as a power generating facility 52 to a power supply destination such as the electrically-driven movable body 22. In the present embodiment, the distribution network 50 electrically connects the power generating facility 52 to the electrically-driven movable body 22 so that electric power can be supplied to the electrically-driven movable body 22 from the power generating facility 52.

The power generating facility 52 includes, for example, electric power plants configured to generate electric power in various forms such as thermal power generation, hydraulic power generation, nuclear power generation, or recyclable energy power generation. The recyclable energy power generation includes, for example, photovoltaic power generation, wind-power generation, geothermal power generation, or hydraulic power generation.

In the present embodiment, the information processing system 1 is communicably connected to the distribution network server 54 via the network 30. The distribution network server 54 may be configured identically or similarly to the server 10. The distribution network server 54 acquires distribution network information. The distribution network information includes information on an electric power amount demanded by a power supply destination of the distribution network 50. The distribution network server 54 may generate information to instruct an electric power amount to be generated to the power generating facility 52 as a power source and output the information to the power generating facility 52, so that power demand of the power supply destination of the distribution network 50 is satisfied.

The distribution network server 54 can function as a community energy management system (CEMS). The CEMS manages energy such as electric power or the like in a whole area. More specifically, the CEMS manages electric power to be supplied from the power generating facility 52 in the area and electric power consumed in the whole area. That is, the CEMS manages demand and supply of electric power in the whole area.

The distribution network server 54 may acquire information on a state of the power generating facility 52. The distribution network server 54 may generate information to instruct an electric power amount to be generated to the power generating facility 52 based on the power generating facility information. The information on the state of the power generating facility 52 is also referred to as power generating facility information. The power generating facility information may include information on an electric power amount outputtable from the power generating facility 52 at present, or the power generating facility information may include information on an electric power amount estimated to be outputtable from the power generating facility 52 in future. More specifically, the power generating facility information may include a prediction result or the like of electric power to be generated by recyclable energy such as photovoltaic power generation or wind power generation. The power generating facility information may include information on a power generation plan of thermal power generation or the like.

Exemplary Operation of Information Processing System 1

The information processing system 1 provides a service to propose the transportation mode 20 to the user 80. The information processing system 1 may receive a registration to the server from the user 80 who wants to receive a proposal about the transportation mode 20. The information processing system 1 may propose the transportation mode 20 to the user 80 who has registered the service. The information processing system 1 may propose the transportation mode 20 to the user 80 who has not registered the service.

In the information processing system 1, the server controlling portion 12 of the server 10 may acquire information on the user 80 who uses the service regardless whether the user 80 has registered the service or not, and the server controlling portion 12 may store the information in the storage portion. The information on the user 80 who uses the service is also referred to as user usage information.

The terminal device 70 acquires information on a travel request from the user 80, that is, travel information. The terminal device 70 may receive an input of the travel information from the user 80 via the input portion 76 or the terminal I/F 74. The terminal device 70 outputs the travel information to the server 10. The server 10 acquires the travel information from the terminal device 70 via the server I/F 14. The travel information may be associated with the user usage information or may include the user usage information.

The distribution network server 54 generates information on power demand and supply in the distribution network 50 configured to supply electric power to the transportation mode 20, that is, distribution network information, and the distribution network server 54 outputs it to the server 10. The server 10 acquires the distribution network information from the distribution network server 54 via the server I/F 14.

The server controlling portion 12 determines a transportation mode 20 to be proposed to the user 80 based on the travel information and the distribution network information thus acquired via the server I/F 14. More specifically, the server controlling portion 12 generates at least one route that connects the departure point 61 to the goal point 62. The departure point 61 and the goal point 62 are specified by the travel information. The server controlling portion 12 extracts a transportation mode 20 usable for the user 80 to travel along the route. The server controlling portion 12 may propose the extracted transportation mode 20 to the user 80. The information on the proposal to the user 80 is also referred to as proposal information. In other words, the proposal information includes information on the transportation mode 20 determined by the server controlling portion 12 to be proposed to the user 80. The server controlling portion 12 may propose information in which the route is associated with the transportation mode 20 to the user 80 as the proposal information. The server controlling portion 12 proposes the transportation mode 20 to the user 80 by outputting the proposal information to the terminal device 70 so that the terminal device 70 notifies the user 80 of the proposal information. The proposal information may be associated with the user usage information.

The server controlling portion 12 may generate, as the proposal information, information in which the generated route is associated with the extracted transportation mode 20 and output the information to the terminal device 70. The server controlling portion 12 may generate, as the proposal information, information in which a time or a cost necessary when the user 80 uses the transportation mode 20 is further associated with the information in which the route is associated with the transportation modes 20, and the server controlling portion 12 may output the information to the terminal device 70.

When the extracted transportation mode 20 includes the electrically-driven movable body 22, the server controlling portion 12 acquires information on a power consumption caused when the user 80 travels by use of the transportation modes 20. The information on the power consumption is also referred to as power consumption information. The server controlling portion 12 may generate, as the proposal information, information in which the power consumption information is further associated with the information in which the route is associated with the transportation mode 20, and the server controlling portion 12 may output the information to the terminal device 70.

The server controlling portion 12 may estimate a time range in which the user 80 uses the transportation mode 20, based on a departure time or an arrival time specified by the proposal information. The time range in which the user 80 uses the transportation mode 20 is also referred to as a usage time range.

The server controlling portion 12 may determine the transportation mode 20 to be proposed to the user 80, based on distribution network information within the estimated usage time range. The server controlling portion 12 may determine the transportation mode 20 to be proposed to the user 80, based on a power reserve rate, for example. More specifically, when a power reserve rate in the estimated usage time range is a predetermined value or more, the server controlling portion 12 may determine a transportation mode 20 that consumes electric power, as the transportation mode 20 to be proposed to the user 80. When the server controlling portion 12 proposes, to the user 80, a transportation mode 20 such as a train that is operated regardless of whether the user 80 uses the transportation mode 20 or not from among the transportation modes 20 that consume electric power, the server controlling portion 12 may propose the transportation mode 20 regardless of the magnitude of the power reserve rate. That is, as a condition that the transportation mode 20 that consumes electric power at the time when the user 80 uses the transportation mode 20 is proposed to the user 80 from among the transportation modes 20 that consume electric power, the server controlling portion 12 may determine whether or not the power reserve rate in the estimated usage time range is the predetermined value or more.

The server controlling portion 12 may determine the transportation mode 20 to be proposed to the user 80 based on distribution network information in a time range before the estimated usage time range. The server controlling portion 12 may determine the transportation mode 20 to be proposed to the user 80 based on whether or not a time range in which the power reserve rate is the predetermined value or more is present before the estimated usage time range, for example. More specifically, the server controlling portion 12 may propose, to the user 80, a transportation mode 20 that can charge its battery in a time range in which the power reserve rate is the predetermined value or more, among time ranges before the estimated usage time range. That is, the server controlling portion 12 may propose, to the user 80, a transportation mode 20 that consumes electric power for the user 80 to use the transportation mode 20, the electric power being charged in advance when the power reserve rate is the predetermined value or more.

When the power reserve rate is less than the predetermined value in the estimated usage time range or its previous time ranges, the server controlling portion 12 may propose, to the user 80, a transportation mode 20 that does not consume electric power. When the power reserve rate is less than the predetermined value in the estimated usage time range or its previous time ranges, the server controlling portion 12 may propose, to the user 80, a transportation mode 20 other than the transportation modes 20 that consume electric power for the user 80 to use the transportation modes 20.

The server controlling portion 12 may propose, to the user 80, a transportation mode 20 that consumes less electric power, as the power reserve rate in the estimated usage time range is smaller. The server controlling portion 12 may propose, to the user 80, a transportation mode 20 that is usable even when the amount of electric power to be charged is small, as the power reserve rate in the previous usage time ranges is smaller than in the estimated usage time range.

As described above, by determining the transportation mode 20 to be proposed to the user 80 based on the travel information and the distribution network information, the server controlling portion 12 can estimate an influence of the operation of the transportation mode 20 on the power demand in the distribution network 50. As a result, accuracy in estimation of the power demand in the distribution network 50 can be improved. Further, the server controlling portion 12 can determine the transportation mode 20 to be proposed to the user 80 so that the peak of the power demand in the distribution network 50 is lowered by equalizing the power demand in the distribution network 50. The power reserve rate in the peak of the power demand in the distribution network 50 can hardly near zero. As a result, stability of power supply from the distribution network 50 can be improved.

Display of Transportation Mode 20 to be Proposed

The server controlling portion 12 outputs proposal information to the terminal device 70. The terminal device 70 outputs the proposal information via the output portion 78 or the terminal I/F 74 so that the user 80 recognizes the proposal information.

The terminal device 70 may cause the output portion 78 to display the proposal information, the output portion 78 being configured as a display device. More specifically, the output portion 78 specifies the departure point 61 and the goal point 62 of the user 80 and displays a proposal screen 60 that specifies at least one route connecting the departure point 61 to the goal point 62.

As illustrated in FIG. 3, for example, the output portion 78 may display the proposal screen 60 in a mode in which at least one route connecting the departure point 61 to the goal point 62 and transportation modes 20 usable in the route are displayed on a map. The mode of the display on the map is also referred to as a map form. In FIG. 3, three proposal routes 41, 42, 43 proposed to the user 80 are displayed. The number of routes to be proposed to the user 80 is not limited to three and may be two or less or may be four or more. Each route may include at least one way point 63 between the departure point 61 and the goal point 62. The number of the way points 63 may be two or more or may be zero.

The output portion 78 proposes, to the user 80, transportation modes 20 usable for the user 80 to travel between the points by displaying the transportation modes 20 on the proposal screen 60.

As transportation modes 20 for traveling along the proposal route 41, a walk icon 64, a bus icon 66, and a taxi icon 68 are displayed. That is, the proposal route 41 is associated with walking, a bus, and a taxi as the transportation modes 20. When the user 80 travels along the proposal route 41, the user 80 can travel by walking and take a bus and a taxi as the transportation modes 20. The bus is assumed a shuttle bus. The bus may be an on-demand bus. The taxi may be replaced with an on-demand bus.

As transportation modes 20 for traveling along the proposal route 42, a bicycle icon 65 and a train icon 67 are displayed. That is, the proposal route 42 is associated with a bicycle and a train as the transportation modes 20. When the user 80 travels along the proposal route 42, the user 80 can use a bicycle and take a train as the transportation modes 20. The bicycle is assumed a rental cycle.

As transportation modes 20 for traveling along the proposal route 43, a walk icon 64 and a passenger-car icon 69 are displayed. That is, the proposal route 43 is associated with walking and a passenger car as the transportation modes 20. When the user 80 travels along the proposal route 43, the user 80 can travel by walking and use a passenger car as the transportation modes 20. The passenger car is assumed a rental car or a shared car. The passenger car may be replaced with an on-demand bus.

The terminal device 70 may output further detailed information on each route or each transportation mode 20. For example, the terminal device 70 may output detailed information on a designated route input by the user 80 from among the proposed routes. The detailed information on the route may include a time necessary to travel by use of the route, a cost necessary to use the route, or the like, for example. For example, the terminal device 70 may output detailed information on a designated transportation mode 20 input by the user 80 from among the proposed transportation modes 20. The detailed information on the transportation mode 20 may include, for example, a time necessary to travel by use of the transportation mode 20, a cost necessary to use the transportation mode 20, a condition necessary to use the transportation mode 20, or the like.

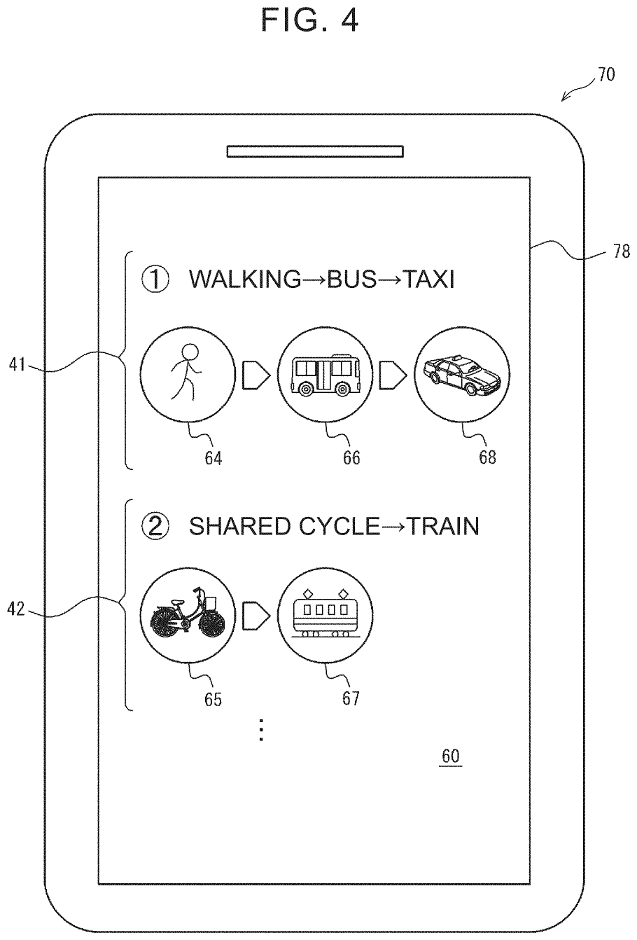

As illustrated in FIG. 4, for example, the output portion 78 may display the proposal screen 60 in a mode in which a list of respective routes and the transportation modes 20 usable in the respective routes is displayed. The mode of the display of the list is also referred to as a list form. More specifically, the terminal device 70 may display the transportation modes 20 usable in each of the proposal routes 41, 42, 43, that is, the transportation modes 20 associated with each route in one line. The terminal device 70 may display a time necessary to travel by use of a route, a cost necessary to use the route, or the like in the same line as a line where the route is displayed, a line adjacent to the line where the route is displayed, or a line near the line where the route is displayed. The terminal device 70 is not limited to these examples and may display the route to be proposed to the user 80 and the transportation modes 20 usable in the route in various other forms such as a text form.

Selection and Reservation of Transportation Mode 20 by User 80

The user 80 can select a route based on information displayed on the proposal screen 60. The terminal device 70 receives, from the user 80, an input to select one route from among the proposal routes 41, 42, and 43 via the input portion 76 or the terminal I/F 74. In a case where the routes are displayed on a map, the terminal device 70 may receive an input by which the user 80 directly designates a route displayed on the map. In a case where the routes are displayed in the list form, the terminal device 70 may receive an input in which the user 80 designates a line indicative of a route. In a case where the routes are displayed in various other forms, the terminal device 70 may receive an input by which the user 80 selects a route in accordance with a displayed form. When the terminal device 70 receives, from the user 80, an input to select a route, the terminal device 70 may consider that the user 80 selects a transportation mode 20 to be used in the route selected by the user 80. In a case where two or more usable transportation modes 20 are associated with the route selected by the user 80, the terminal device 70 can consider that the user 80 has collectively selected all the usable transportation modes 20 associated with the route. The terminal device 70 may receive an input by which the user 80 further narrows down the two or more transportation modes 20 associated with the route selected by the user 80 and selects a transportation mode 20 from the two or more transportation modes 20.

The user 80 can select a transportation mode 20 based on information displayed on the proposal screen 60. The terminal device 70 receives, from the user 80, an input to select a transportation mode 20 included in the proposal routes 41, 42, and 43 via the input portion 76 or the terminal I/F 74. In a case where the transportation modes 20 are displayed on a map, the terminal device 70 may receive an input by which the user 80 directly designates an icon indicative of a transportation mode 20 displayed on the map. In a case where the transportation modes 20 are displayed in a table mode, the terminal device 70 may receive an input by which the user 80 designates a cell indicative of a transportation mode 20. In a case where the transportation modes 20 are displayed in various other modes, the terminal device 70 may receive an input by which the user 80 selects a transportation mode 20 in accordance with a displayed form.

When the terminal device 70 receives, from the user 80, an input to select a route or a transportation mode 20, the terminal device 70 outputs the transportation mode 20 selected by the user 80 to the server 10.

The server controlling portion 12 of the server 10 may consider that the user 80 have reserved the transportation mode 20 selected by the user 80 and may set a usage reservation of the transportation mode 20. When the user 80 selects a transportation mode 20, the terminal device 70 may further receive an input to reserve the use of the transportation mode 20 and may output information on the reservation to the server 10. The server controlling portion 12 may acquire the information on the reservation from the terminal device 70 and may set a usage reservation of the transportation mode 20.

The server controlling portion 12 estimates a power consumption of the transportation mode 20 based on the usage reservation of the transportation mode 20 by the user 80. The server controlling portion 12 estimates power demand in the distribution network 50 based on the estimation result of the power consumption of the transportation mode 20.

When the user 80 uses the transportation mode 20 just as the usage reservation has been made, the server controlling portion 12 may give an incentive to the user 80. This can reduce the frequency of changing or cancelling the reservation by the user 80. When the change of the reservation or the cancellation of the reservation is reduced, accuracy in estimation of the operation of the transportation mode 20 can be improved. As a result, accuracy in estimation of the power demand by the server controlling portion 12 can be improved.

The server controlling portion 12 may determine an operation schedule for the transportation mode 20 based on the reservation made by the user 80. More specifically, the server controlling portion 12 may determine the operation schedule so that the transportation mode 20 is not operated during a period in which no usage reservation of the transportation mode 20 is made. The server controlling portion 12 may determine the operation schedule so that the frequency of the operation of the transportation mode 20 is reduced during a period in which the number of usage reservations of the transportation mode 20 is small. The server controlling portion 12 may determine the operation schedule such that, in terms of the period in which the number of usage reservations of the transportation mode 20 is small, the usage reservations are changed to other periods so that the transportation mode 20 is not operated in the period. The transportation mode 20 can be operated efficiently because its operation schedule is determined based on the reservations. As a result, the power consumption of the transportation mode 20 can be reduced.

Grant of Incentive

The server controlling portion 12 outputs, to the terminal device 70, information on the usage reservation of the transportation mode 20 selected by the user 80. The terminal controlling portion 72 may notify the user 80 of the information on the usage reservation by causing the output portion 78 to display the information on the usage reservation. The user 80 may use the transportation mode 20 based on the usage reservation. The terminal controlling portion 72 outputs, to the server 10, information on a usage result of the transportation mode 20 by the user 80. The information on the usage result may include information that specifies a fact that the user 80 has used the transportation mode 20 just as the usage reservation has been made. The information on the usage result may include information that specifies a fact that the user 80 has cancelled or changed the usage reservation. That is, the information on the usage result may include information that specifies a fact that the user 80 has not used the transportation mode 20 just as the usage reservation has been made.

When the server controlling portion 12 acquires, as the information on the usage result, the information that specifies a fact that the user 80 has used the transportation mode 20 just as the usage reservation has been made, the server controlling portion 12 may give an incentive to the user 80. More specifically, the server controlling portion 12 may give an incentive to the user 80 by outputting information on the incentive to the terminal device 70. The server controlling portion 12 may provide the information on the incentive to the user 80 who has made the usage reservation of the transportation mode 20 by associating the user usage information with the information on the incentive.

The incentive may be given as a point, for example. The incentive may be given as a point that is applicable to the payment of usage fees of the transportation mode 20, for example. The incentive may be given as electronic money, for example. The incentive may be given as a point exchangeable with valuables or charged services. The point may be exchangeable with a usage ticket for footbath. The point may be exchangeable with a usage ticket for the transportation mode 20. The point is not limited to these examples and may be exchangeable with various other valuables or charged services.

Since an incentive is given to the user 80 when the user 80 has used the transportation mode 20 just as the usage reservation has been made, the transportation mode 20 is easily used as reserved. As a result, the power demand in the distribution network 50 can be managed easily.

Exemplary Procedure of Information Processing Method

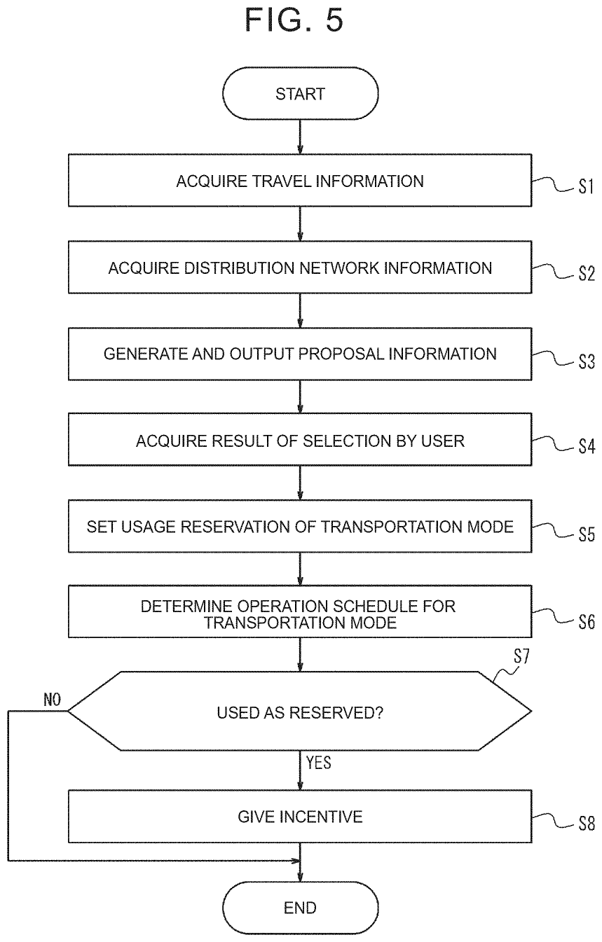

The server controlling portion 12 may execute an information processing method including the procedure of the flowchart illustrated in FIG. 5. The information processing method may be implemented as an information processing program to be executed by a processor constituting the server controlling portion 12.

The server controlling portion 12 acquires travel information from the terminal device 70 (step S1). The server controlling portion 12 acquires distribution network information from the distribution network server 54 (step S2). The server controlling portion 12 generates proposal information based on the travel information and the distribution network information and outputs the proposal information (step S3). The server controlling portion 12 acquires a result of a transportation mode 20 selected by the user 80 based on the proposal information from the terminal device 70 (step S4). The server controlling portion 12 sets a reservation to the transportation mode 20 selected by the user 80 so that the user 80 uses the transportation mode 20 (step S5). In the process of step S5, the server controlling portion 12 may output, to the terminal device 70, information on the reservation thus set. The server controlling portion 12 determines an operation schedule for the transportation mode 20 based on the usage reservation of the transportation mode 20 (step S6). In the process of step S6, the server controlling portion 12 may update an operation schedule that has been already determined.

The server controlling portion 12 acquires information on a result indicative of whether the user 80 has used the transportation mode 20 or not from the terminal device 70 and determines whether or not the transportation mode 20 has been used as reserved (step S7). When the transportation mode 20 has not been used as reserved (step S7: NO), the server controlling portion 12 ends the execution of the procedure of the flowchart in FIG. 5. When the transportation mode 20 has been used as reserved (step S7: YES), the server controlling portion 12 gives an incentive to the user 80 (step S8). More specifically, the server controlling portion 12 may output information on the incentive to the terminal device 70 possessed by the user 80. After the process of step S8 is executed, the server controlling portion 12 ends the execution of the procedure of the flowchart in FIG. 5.

Exemplary Procedure of Terminal Control Method

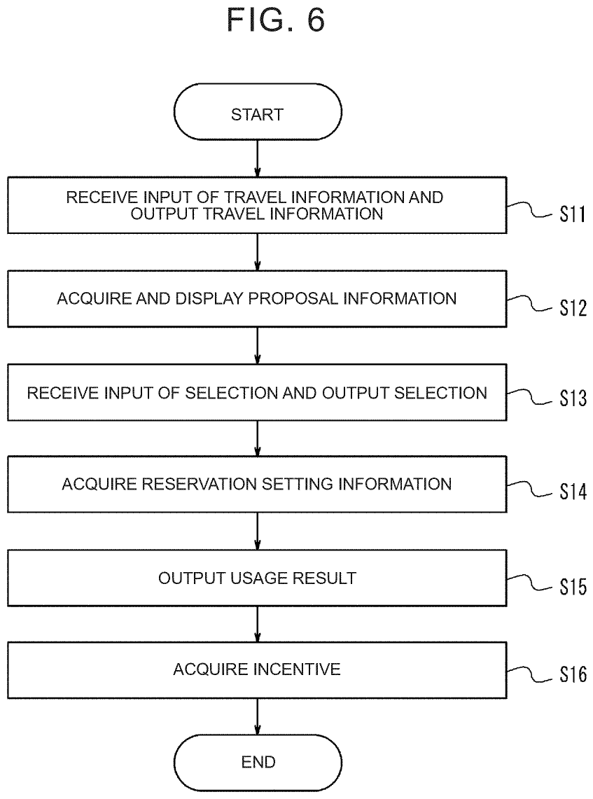

The terminal controlling portion 72 of the terminal device 70 may execute a terminal control method including the procedure of the flowchart illustrated in FIG. 6. The terminal control method may be implemented as a terminal control program be executed by a processor constituting the terminal controlling portion 72.

The terminal controlling portion 72 receives an input of travel information from the user 80 and outputs it to the server 10 (step S11). The terminal controlling portion 72 acquires proposal information from the server 10 and displays it on the output portion 78 (step S12). The terminal controlling portion 72 receives an input to select a transportation mode 20 from the user 80 and output it to the server 10 (step S13). In the process of step S13, the terminal controlling portion 72 may further receive an input to make a reservation for the user 80 to use the transportation mode 20 and output it to the server 10. The terminal controlling portion 72 acquires reservation setting information for the user 80 to use the transportation mode 20 from the server 10 (step S14). The terminal controlling portion 72 outputs a result indicating that the user 80 has used the transportation mode 20 (step S15). More specifically, the terminal controlling portion 72 outputs information to specify whether or not the user 80 has used the transportation mode 20 just as the user 80 has reserved. The terminal controlling portion 72 acquires, from the server 10, information on an incentive to be given to the user 80 when the user 80 has used the transportation mode 20 (step S16). More specifically, the terminal controlling portion 72 may acquire, from the server 10, the information on the incentive when the user 80 has used the transportation mode 20 just as the user 80 has reserved. After the process of step S16 is executed, the terminal controlling portion 72 ends the execution of the procedure of the flowchart in FIG. 6.

Summary

As described above, the information processing system 1 according to the present embodiment can propose the transportation mode 20 to the user 80 based on information on a travel request from the user 80 and information on the distribution network 50. With such a configuration, power demand can be equalized. As a result, stability of power supply from the distribution network 50 can be improved. Further, the information processing system 1 may determine an operation schedule for the transportation mode 20 based on a usage reservation made by the user 80. With such a configuration, the transportation mode 20 can be operated efficiently. As a result, the power consumption of the transportation mode 20 can be reduced. Further, the information processing system 1 may give an incentive to the user 80 based on a usage result of the user 80. With such a configuration, the transportation mode 20 can be easily used as reserved. As a result, the power demand in the distribution network 50 can be managed easily. Further, the stability of the power supply can be improved.

### Other Embodiments

Proposal of Transportation Mode 20 Based on Distribution Network Information

As described above, the server controlling portion 12 may determine the transportation mode 20 to be proposed to the user 80 based on the distribution network information. The server controlling portion 12 may determine the transportation mode 20 to be proposed to the user 80 based on other pieces of information except for the power reserve rate of the distribution network 50. For example, the server controlling portion 12 may determine the transportation mode 20 to be proposed to the user 80 based on a power generation schedule in a recyclable-energy power generating facility configured to supply electric power to the distribution network 50. When the transportation mode 20 can be operated by consuming electric power generated by the recyclable-energy power generating facility, the server controlling portion 12 may propose the use of the transportation mode 20 to the user 80. The server controlling portion 12 may propose the use of the transportation mode 20 to the user 80 so that the ratio of electric power generated by the recyclable-energy power generating facility in electric power consumed by the transportation mode 20 is larger. When the user 80 uses the transportation mode 20 that consumes electric power generated by the recyclable-energy power generating facility, the server controlling portion 12 may give an incentive to the user 80 based on the ratio of the electric power generated by the recyclable-energy power generating facility in the power consumption of the transportation mode 20.

Management of Power Supply to Transportation Mode 20 Based on Distribution Network Information

The server controlling portion 12 may manage supply of electric power to the transportation mode 20 that consumes electric power, e.g., the electrically-driven movable body 22, based on the distribution network information. For example, the server controlling portion 12 may determine an operation schedule for the electrically-driven movable body 22 based on the distribution network information. That is, the server controlling portion 12 may manage the supply of electric power to the electrically-driven movable body 22 by managing a power consumption of the electrically-driven movable body 22. More specifically, while the server controlling portion 12 may operate the electrically-driven movable body 22 that operates by immediately consuming electric power supplied from the distribution network 50 without charging the electric power during a period in which the power reserve rate is large, the server controlling portion 12 may stop the operation of the electrically-driven movable body 22 during a period in which the power reserve rate is expected to be small. The server controlling portion 12 may determine the operation schedule for the electrically-driven movable body 22 so that the number of the electrically-driven movable bodies 22 to be operated is increased as the power reserve rate is larger. When the server controlling portion 12 manages the supply of electric power to the electrically-driven movable body 22 based on the distribution network information, the power demand can be equalized.

The electrically-driven movable body 22 may include a battery and may be driven by electric power charged in the battery. That is, the electrically-driven movable body 22 may be configured to be chargeable. The server controlling portion 12 may manage the supply of electric power to the electrically-driven movable body 22 by determining a charging schedule for the electrically-driven movable body 22 configured to be chargeable.

The server controlling portion 12 may determine the charging schedule for the electrically-driven movable body 22 based on the usage reservation made by the user 80. For example, the server controlling portion 12 may determine the charging schedule for the electrically-driven movable body 22 configured to be chargeable based on the usage reservation for the user 80 to use the transportation mode 20. More specifically, the server controlling portion 12 may determine the charging schedule so that charging of the transportation mode 20 can be finished before a reservation time at which the user 80 is to use the transportation mode 20.

The server controlling portion 12 may determine the charging schedule for the electrically-driven movable body 22 further based on the distribution network information. For example, the server controlling portion 12 may determine the charging schedule for the electrically-driven movable body 22 so that the electrically-driven movable body 22 is charged during a period in which the power reserve rate is larger.

The server controlling portion 12 may determine the charging schedule for the electrically-driven movable body 22 based on a power generation schedule in the recyclable-energy power generating facility. For example, the server controlling portion 12 may determine the charging schedule for the electrically-driven movable body 22 so that the electrically-driven movable body 22 is charged during a period in which the power generation amount of the recyclable-energy power generating facility is large. Further, the server controlling portion 12 may determine the charging schedule for the electrically-driven movable body 22 based on a power generation schedule in a recyclable-energy power generating facility placed in a predetermined area. With such a configuration, a loss of electric power generated by the recyclable-energy power generating facility can be reduced.

The embodiments of this disclosure have been described based on the drawings and the examples, but it should be noted that a person skilled in the art can easily make various modifications and alterations based on this disclosure. Accordingly, it should be noted that these modifications and alterations are included in the scope of this disclosure. For example, functions and the like included in respective means, respective steps, and the like can be rearranged within a range where the rearrangement is not logically inconsistent with the above embodiment, and a plurality of means, steps, and the like may be combined into one or may be divided.

1. An information processing device comprising:
an interface configured to acquire information on a travel request from a user via a terminal device of the user and to acquire information on a distribution network configured to supply electric power to at least one transportation mode usable by the user; and
a controlling portion configured to determine a transportation mode to be proposed to the user based on the information on the travel request from the user and the information on the distribution network and to output information on the transportation mode thus determined to the terminal device.

2. The information processing device according to claim 1, wherein the controlling portion receives a usage reservation of the transportation mode from the user and gives an incentive to the user when the user has traveled just as the user has made the usage reservation.

3. The information processing device according to claim 2, wherein the controlling portion determines an operation schedule for the transportation mode based on the usage reservation made by the user.

4. The information processing device according to claim 2, wherein, in a case where the transportation mode reserved by the user includes a rechargeable electrically-driven movable body, the controlling portion determines a charging schedule for the rechargeable electrically-driven movable body based on the reservation made by the user.

5. The information processing device according to claim 1, wherein the controlling portion determines the transportation mode to be proposed to the user based on a power generation schedule in a recyclable-energy power generating facility configured to supply electric power to the distribution network.

6. The information processing device according to claim 5, wherein the controlling portion gives an incentive to the user based on a ratio of electric power generated by the recyclable-energy power generating facility in electric power consumed by the transportation mode used by the user.

7. The information processing device according to claim 5, wherein, in a case where the transportation mode reserved by the user includes a rechargeable electrically-driven movable body, the controlling portion determines a charging schedule for the rechargeable electrically-driven movable body based on the power generation schedule in the recyclable-energy power generating facility.

8. The information processing device according to claim 7, wherein the controlling portion determines the charging schedule for the electrically-driven movable body based on a power generation schedule in a recyclable-energy power generating facility placed in a predetermined area.

9. An information processing system comprising:
the information processing device according to claim 1; and
the terminal device.

10. An information processing method comprising:
acquiring information on a travel request from a user via a terminal device of the user;
acquiring information on a distribution network configured to supply electric power to at least one transportation mode usable by the user; and
determining a transportation mode to be proposed to the user based on the information on the travel request from the user and the information on the distribution network and to output information on the transportation mode thus determined to the terminal device.

11. The information processing method according to claim 10, further comprising:
receiving a usage reservation to use the transportation mode from the user; and
giving an incentive to the user when the user has traveled just as the user has made the usage reservation.

12. The information processing method according to claim 11, further comprising determining an operation schedule for the transportation mode based on the usage reservation made by the user.

13. The information processing method according to claim 11, further comprising, in a case where the transportation mode reserved by the user includes a rechargeable electrically-driven movable body, determining a charging schedule for the rechargeable electrically-driven movable body based on the reservation made by the user.

14. The information processing method according to claim 10, further comprising determining the transportation mode to be proposed to the user based on a power generation schedule in a recyclable-energy power generating facility configured to supply electric power to the distribution network.

15. The information processing method according to claim 14, further comprising giving an incentive to the user based on a ratio of electric power generated by the recyclable-energy power generating facility in electric power consumed by the transportation mode used by the user.

16. The information processing method according to claim 14, further comprising, in a case where the transportation mode reserved by the user includes a rechargeable electrically-driven movable body, determining a charging schedule for the rechargeable electrically-driven movable body based on the power generation schedule in the recyclable-energy power generating facility.

17. The information processing method according to claim 16, further comprising determining the charging schedule for the electrically-driven movable body based on a power generation schedule in a recyclable-energy power generating facility placed in a predetermined area.

18. A terminal device comprising a controlling portion, wherein:
the controlling portion receives an input of information on a travel request from a user and outputs the information to an information processing device;
the controlling portion acquires, from the information processing device, information on a transportation mode proposed based on the information on the travel request from the user and information on a distribution network configured to supply electric power to at least one transportation mode usable by the user; and
the controlling portion notifies the user of the information on the transportation mode.

19. The terminal device according to claim 18, wherein the controlling portion acquires, from the information processing device, information on an incentive to be given to the user when the user has used the transportation mode.

20. The terminal device according to claim 18, wherein the controlling portion receives an input to make a reservation for the user to use the transportation mode and outputs information on the reservation to the information processing device.
